(19) United States
(12) Patent Application Publication
(10) Pub. No.: US 2005/0136786 A1
(43) Pub. Date: Jun. 23, 2005

(54) Hollow cathodes with getter layers on inner and outer surfaces

(76) Inventors: Alessandro Gallitognotta, Origgio (IT); Claudio Boffito, Rho (IT); Alessio Corazza, Como (IT)

Correspondence Address: PERKINS COIE LLP, P.O. BOX 2168, MENLO PARK, CA, 94026, US

(21) Appl. No.: 11/036,567

(22) Filed: Jan. 14, 2005

Related U.S. Application Data
(62) Division of application No. 10/292,214, filed on Nov. 12, 2002.

(30) Foreign Application Priority Data
Nov. 12, 2001 (IT) MI 2001A 002389

(51) Int. Cl. H01J 9/02

(52) U.S. Cl. 445/31

(57) ABSTRACT

A hollow cathode having at least a portion of the inner, outer or both surfaces coated with a layer of a getter material is described. Some methods for the production of the hollow cathode of the invention are also described, which include cathodic and electrophoretic deposition of the getter layer onto the hollow cathode.

### CROSS-REFERENCE TO RELATED APPLICATIONS

This application claims the benefit of Italian Patent Application MI2001 A 002389 filed Nov. 12, 2001, and U.S. patent application Ser. No. 10/292,214 filed Nov. 12, 2002, both of which are incorporated herein by reference.

### BACKGROUND

Discharge lamps are commonly defined and known in the art as all lamps in which the emission of a radiation, which can be visible, infrared, or ultraviolet, takes place as a consequence of electric discharge in a gaseous medium. The discharge is triggered and sustained by the potential difference applied to two electrodes placed at opposing ends of the lamp.

The cathodes for lamps can have various shapes, for example filaments or spiral wound filaments, or other shapes. A particularly advantageous cathode shape is the hollow cathode. Hollow cathodes have generally the shape of a hollow cylinder which is open at the end facing the discharge zone, and closed at the opposite end. As is well known to those skilled in the art, one advantage given by the hollow cathodes with respect to other cathode shapes is that there is a lower potential difference (of about 5-10%) required to “light” the discharge. Another advantage of the hollow cathode is a lower intensity of the “sputtering” phenomenon by the cathode, namely the emission of atoms or ions from the cathodic material that can deposit on adjacent parts, among which include the glass walls of the lamp, thus reducing the brilliancy of the lamp. Examples of lamps with hollow cathodes are described for instance in U.S. Pat. Nos. 4,437,038, 4,461,970, 4,578,618, 4,698,550, 4,833,366 and 4,885,504 as well as in the published Japan patent application 2000-133201, which are incorporated by reference.

It is also known by those skilled in the art that in order to assure a proper operation of these lamps throughout their lives, it is necessary to assure the consistency of the mixtures forming the gaseous medium of the discharge. These mixtures are, in general, mainly formed by one or several rare gases, such as argon or neon, and in many cases some milligrams of mercury. The composition of these mixtures can vary from the desired one, both because of impurities remaining in the lamp from the production process, and because of those released over time by the same materials forming the lamp or permeating inward from the walls thereof. Impurities present in these mixtures can damage the working of the lamp in various ways. For example, oxygen or oxygenated species can react with mercury to form HgO, thus removing the metal from its function. Hydrogen can cause discharge striking difficulties (and consequently lighting difficulties of the lamp) or change the operating electrical parameters of the lamp, increasing its energy consumption.

In order to eliminate these impurities it is known by those skilled in the art to introduce a getter material into the lamps. Getter materials have the function of fixing the impurities through a chemical reaction, thus removing them from the gaseous medium. Getter materials widely used to this purpose include the zirconium-aluminum alloys described in U.S. Pat. No. 3,203,901; the zirconium-iron alloys described in U.S. Pat. No. 4,306,887; the zirconium-vanadium-iron alloys described in U.S. Pat. No. 4,312,669; and the zirconium-cobalt-mischmetal alloy described in U.S. Pat. No. 5,961,750 (mischmetal is a mixture of rare earth metals). All four of these US patents are hereby incorporated by reference. These getter materials are generally introduced in the lamps in the form of getter devices formed by powders of material that are fixed to a support. Usually, getter devices for lamps are formed by a cut down size of a supporting metal strip, flat or variously folded, onto which the powder is fixed by rolling; an example of such a getter device for lamps is described in U.S. Pat. No. 5,825,127, which is hereby incorporated by reference.

As is generally known by those skilled in the art, in some cases the getter device is formed by a getter material pill simply inserted into the lamp, it is highly preferable when it is fixed to some constituting element of the lamp. The reason it is desirable to affix the getter material to a constituting element of the lamp is that a getter which is not fixed does not lie generally in the hot areas of the lamp, and so its gas absorbing efficiency decreases, and further it can interfere with the light emission. The device is accordingly almost always fixed (in general by spot welding), for instance to the cathodic support, whereas in some cases a suitable support is added to the lamp. In all cases, however, additional steps are required in the production process of the lamp. In addition, there are lamps having an extremely reduced diameter, such as those used for backlighting liquid crystal screens, which have diameters not larger than 2-3 millimeters. In a case with such a narrow diameter it is difficult to find a suitable arrangement of the getter device within the lamp, and the assembling operations for the device may become extremely difficult.

### SUMMARY

A technique for overcoming some of the deficiencies of the prior art may include crafting a hollow cathode with a getter layer on an inner wall and an outer wall of the hollow cathode with a substantially open end. The hollow cathode may be coupled to a lamp structure in such a way that the substantially open end is directed toward a discharge zone of the lamp.

In an embodiment, cathode constructed according to the technique may include an elongated cylindrical hollow part having a first end, a second end, an inner surface, and an outer surface. The first end may be substantially closed and the second end may be substantially open. Alternatively, the first end may be completely closed, the second end may be completely open, or the first end may be completely closed and the second end may be completely open. In an embodiment, at least a portion of the inner surface and at least a portion of the outer surface may include a layer of getter material.

In various alternatives, a cylindrical hollow part of a cathode may be made essentially or completely of metal. The metal may include, for example, nickel, molybdenum, tantalum, or niobium. In other alternatives, a getter layer of a cathode may include, for example, titanium, vanadium, yttrium, zirconium, niobium, hafnium, or tantalum. In another alternative, a getter layer of a cathode may include an alloy of, for example, zirconium or titanium combined with, for example, aluminum or a transition metal. In another alternative, a getter layer of a cathode may be formed by cathodic deposition, electrophoretic deposition, or some other technique for applying a getter layer to a cathode that is compatible with the teachings provided herein. The layer of getter material, in an embodiment, may be less than 20 microns thick. In this embodiment, the technique used to form the getter layer must be capable of applying the getter layer at 20 microns of thickness.

In another embodiment, a cathode includes a cylindrical hollow part and a getter layer. In an embodiment, the cylindrical hollow part has an inner surface and an outer surface and is substantially closed at a first end and substantially open an opposed end. In an alternative, the cylindrical hollow part may be completely closed at a first end or completely open at an opposed end, or both. In an embodiment, the getter layer at least partially coats the cylindrical hollow part on the outer and inner surface.

In an embodiment, a discharge lamp system constructed according to the technique may include a lamp structure, a hollow cathode, a fixed part, and a getter layer. The hollow cathode may include a first end and a second end, wherein the first end is substantially open and the second end is substantially closed. Alternatively, one or both of the first end and second end may be completely open or completely closed. In an embodiment, the fixed part may couple the hollow cathode to the lamp structure. In another embodiment, the fixed part may be coupled to the second end of the hollow cathode. In an embodiment, the getter layer may be supported by an inner and outer wall of the hollow cathode. For example, the getter layer may be coupled to the inner and outer wall, affixed to the inner and outer wall, or attached in some manner.

In an embodiment, a lamp structure may include a light bulb, wherein a fixed part extends through the light bulb. The fixed part may be coupled to a hollow cathode within the bulb. A substantially open part of the hollow cathode may face a discharge zone of the lamp. The fixed portion may include an electrical conductor for connecting the hollow cathode to a power source. In addition, the fixed part may support the hollow cathode.

### BRIEF DESCRIPTION OF THE DRAWINGS

Embodiments of the invention are illustrated in the figures. However, the embodiments and figures are illustrative rather than limiting; they provide examples of the invention.

FIG. 1 shows a section of the end part of a discharge lamp having a hollow cathode not coated with getter material.

FIGS. 2 to 4 show sections of various possible embodiments of the hollow cathode according to embodiments.

FIG. 5 shows a mode for obtaining a hollow cathode according to an embodiment.

### DETAILED DESCRIPTION

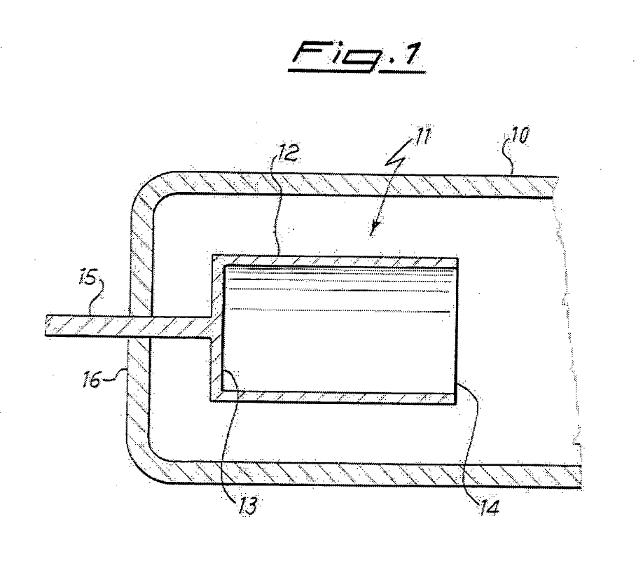

Referring now to FIG. 1, a section of the end part of a lamp 10 containing a hollow cathode 11 represented in its most general shape and without any coating formed of a getter layer is shown. The cathode is made of metal and is formed by a cylindrical hollow part 12 having a closed end 13 and an open end 14. At end 13 there is fixed a part 15 formed in general by a metallic wire; this part 15 is generally fixed to the closed end of lamp 16, for example by inserting it in the glass when this is let soften by heat to allow the sealing of part 16. Part 15 fulfils the double function of a support of cylindrical hollow part 12 and of an electric conductor for connecting cylindrical hollow part 12 to the outside power. Both cylindrical hollow part 12 and part 15 may form a single piece, but more generally they are two parts fixed to each other for example by heat seal or mechanically by compression of cylindrical hollow part 12 around part 15.

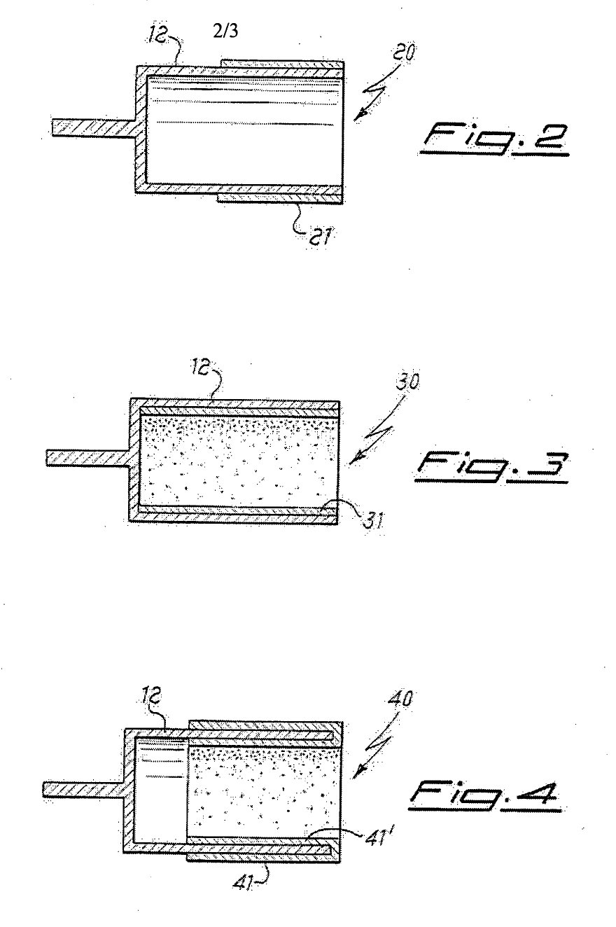

FIGS. 2 to 4 show different embodiments of inventive cathodes as embodied in the present invention, namely, hollow cathodes having at least a part of the surface coated with a getter layer. In particular FIG. 2 shows a hollow cathode 20 wherein a getter layer 21 is only present on a part of outer surface of cylindrical hollow part 12. FIG. 3 shows a hollow cathode 30 wherein a getter layer 31 is only present on inner surface of the cylindrical hollow part 12. FIG. 4 shows a hollow cathode 40 wherein two getter layers 41, 41′ are present both on a portion of outer surface and on a portion of inner surface of cylindrical hollow part 12.

As it will be apparent to people skilled in the art, although in the figures only some embodiments have been represented, the coatings of the two surfaces (inner and outer) of cylindrical hollow part 12 with a getter material may be total or partial. For example, in the case of FIG. 2, the layer 21 could totally coat the outer surface of cylindrical hollow part 12, or in the case of FIG. 4, a partial coating of inner surface, and total coating of outer surface may be appropriate. Other combinations of coatings could occur as can be appreciated by those skilled in the art.

Cylindrical hollow part 12 is made, for example, of nickel or, according to the teaching of Japan patent application 2000-133201, which is hereby incorporated by reference, it can be formed with refractory metals such as tantalum, molybdenum or niobium, which show a reduced sputtering phenomenon.

The getter layer can include any of the metals that are known to have a high reactivity with gases, such as, for example, titanium, vanadium yttrium, zirconium, niobium, hafnium and tantalum. In an embodiment the use of titanium and zirconium is used for gettering purposes. In an alternative embodiment, it is possible to use a getter alloy, which may be an alloy based on zirconium or titanium combined with one or more elements which are selected among the transition metals and aluminum, such as for instance the alloys described in one or more of the previously identified patents, which have been incorporated by reference.

The layer of getter material 21, 31, 41, or 41′ can have a thickness between few microns (μm) and some hundreds of microns, depending on the technique used to produce it and according to the diameter of cylindrical hollow part 12. In the case of hollow cathodes in which cylindrical hollow part 12 has a diameter of about 1 millimeter, it is preferable that the thickness of the getter layer 21, 31, 41, or 41′ is as small as possible, insofar as the getter material is enough to effectively fulfill the function of absorbing the gaseous impurities, as can be appreciated by those skilled in the art.

The layer of getter material does not alter the functionality of the cathode, as it was observed that these materials have work function values not exceeding those of the metals employed to produce cylindrical hollow part 12, and consequently the electronic emissive power of the cathode is not reduced.

Another aspect of the invention includes methods for producing hollow cathodes with a layer of getter material. According to a first embodiment of this second aspect, the layer of getter material can be produced by cathodic deposition, a technique better known in the field of thin layers production as “sputtering.” As it is known by those skilled in the art, in sputtering the support to be coated (in this case a hollow cathode) and a generally cylindrical body (called the “target”), made of the material intended to form the layer, are placed in a suitable chamber. The chamber is evacuated and then a rare gas, usually argon, is backfilled at a pressure of about 10⁻²-10⁻³ mbar. By applying a potential difference between the support and the target (the latter being kept at the cathodic potential) a plasma in argon is produced with formation of Ar⁺ ions which are accelerated by the electric field towards the target, thus eroding it by impact; the particles removed from the target (ions, atoms or “clusters” of atoms) deposit on the available surfaces, among which the ones of the support, forming a thin layer; for further details about principles and conditions of use, reference is made to the very abundant sectorial literature on sputtering. The obtaining of a getter layer formed by a single metal, for example titanium or zirconium, can be achieved with standard technical procedures.

However, the production of alloy layers with this technique may result in complications owing to the difficulties encountered in producing a target of getter material. These difficulties can be overcome by having recourse to the targets described in international patent application WO 02/00959 in the name of the applicant. This technique is preferably used when the getter layers no more than about 20 μm thick are to be produced, and hence usually effective in the case of hollow cathodes with narrow diameter.

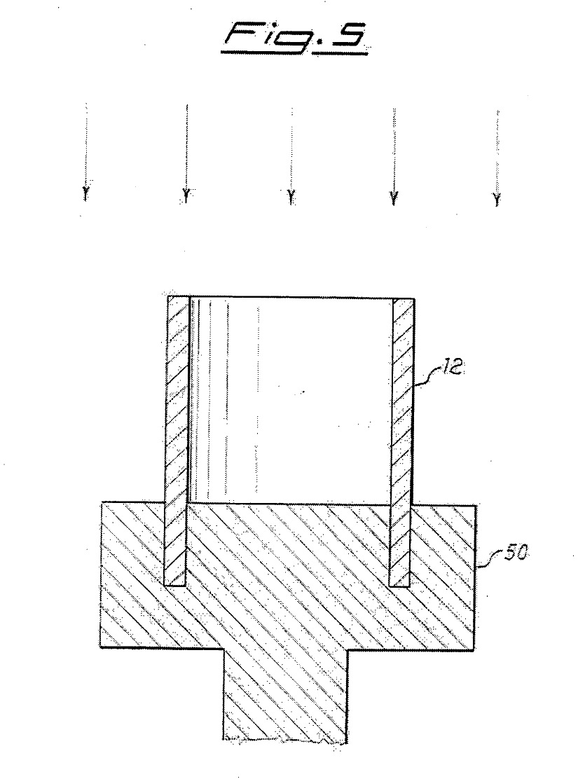

Partial coatings of surfaces of cylindrical hollow part 12 can be obtained in this case by having recourse to masking, for instance by using, during the deposition, supporting elements of cylindrical hollow part 12 that are suitably shaped and selectively covering a portion of the surface thereof An example of this is shown in FIG. 5 regarding the production of a hollow cathode of a type described previously with reference to FIG. 4 (e.g., the hollow cathode 40). In this case, during the deposition, cylindrical hollow part 12 is supported by an element 50 which masks a portion of both cylindrical surfaces (inner and outer) of the part; in FIG. 5 the arrows indicate the coming direction of the particles of material to be deposited. At the end of deposition, the region free of deposited getter is used for its fixing to part 15, whereas the region coated with getter is the one facing the lamp zone wherein the discharge occurs.

Another method for the production of a cathode coated with a getter layer according to the present invention is by electrophoresis. The production principles of layers of getter material by this way are exposed in U.S. Pat. No. 5,242,559 in the name of the applicant, which is hereby incorporated by reference. In this case, a suspension of fine particles of getter material in a liquid is prepared, and the support to be coated (cylindrical hollow part 12) is dipped in the suspension. By suitably applying a potential difference between the support to be coated and a subsidiary electrode (also dipped in the suspension), a transport of particles of getter material towards the support takes place. The obtained deposit is then stiffened through heat treatments. In this case the partial or complete coating of cylindrical hollow part 12 can be obtained by simply partially or totally dipping said cylindrical hollow part in the suspension. In such a case too it is further possible to selectively coat one of the two surfaces, inner or outer, by using a proper support of cylindrical hollow part 12, similarly to what previously explained in the case of element 50 above. This technique is generally more appropriate in the production of thicker getter layers than those obtained by sputtering, with the possibility of easily and quickly forming layers having thickness up to some hundreds of μm.

Finally, when cylindrical hollow part 12 is formed of a refractory metal such as described in Japan application 2000-133201, the coating can be carried out by simple dipping in a molten bath with a composition corresponding to that of the getter metal or alloy to be deposited. Titanium and zirconium melt respectively at about 1650 and 1850° C., and all previously cited zirconium-based alloys melt below 1500° C., whereas molybdenum melts at about 2600° C., niobium melts at about 2470° C. and tantalum at about 3000° C., and it is thus possible to dip, without any change, parts made of these metals in molten baths of getter metals or alloys. In this case too, by totally or partially dipping cylindrical hollow part 12 in the bath, a partial or complete coating with the getter layer can be obtained.

While this invention has been described by way of example in terms of certain embodiments, it will be appreciated by those skilled in the art that certain modifications, permutations and equivalents thereof are within the inventive scope of the present invention. For example, getter materials may be deposited on the hollow cathode by other techniques which would be appropriate, such as arc generated plasma deposition, ionic beam deposition, and laser ablation. It is therefore intended that the following appended claims include all such modifications, permutations and equivalents as fall within the true spirit and scope of the present invention.

1-29. (canceled)

30. A cathode comprising an elongated cylindrical hollow part having a first end, a second end, an inner surface, and an outer surface, wherein the first end is substantially closed and the second end is substantially open, wherein at least a portion of the inner surface and at least a portion of the outer surface includes a layer of getter material.

31. The cathode of claim 30, wherein said cylindrical hollow part is made essentially of metal.

32. The cathode of claim 31, wherein said metal includes material chosen from among the group consisting of nickel, molybdenum, tantalum, and niobium.

33. The cathode of claim 30, wherein said layer of getter material includes a metal selected among the group consisting of: titanium, vanadium, yttrium, zirconium, niobium, hafnium, and tantalum.

34. The cathode of claim 30, wherein said layer of getter material includes an alloy which includes zirconium or titanium combined with one or more elements selected among the group of transition metals and aluminum.

35. The cathode of claim 30, wherein said getter layer is formed by cathodic deposition.

36. The cathode of claim 30, wherein said getter layer is formed by electrophoretic deposition.

37. The cathode of claim 30, wherein said layer of getter material is less than 20 microns thick.

38. A cathode comprising:
a cylindrical hollow part with an inner surface and an outer surface, wherein said cylindrical hollow part is substantially closed at a first end and substantially open an opposed end; and
a getter layer at least partially coating the inner surface and the outer surface of the cylindrical hollow part.

39. The cathode of claim 38, wherein said getter layer is formed with thickness less than 20 μm.

40. The cathode of claim 38, wherein said cylindrical hollow part is made of tantalum, molybdenum, or niobium, further comprising.

41. The cathode of claim 38, wherein said getter layer includes a metal or alloy.

42. The cathode of claim 38, wherein said cylindrical hollow part is made of a getter metal selected from the group consisting of: tantalum, molybdenum, or niobium.

43. The cathode of claim 38, wherein said getter metal is selected from the group consisting of: titanium, vanadium, yttrium, zirconium, niobium, hafnium, and tantalum.

44. A discharge lamp system comprising:
a lamp structure;
a hollow cathode having a first end and a second end, wherein the first end is substantially open and the second end is substantially closed;
a fixed part, coupling the hollow cathode to the lamp structure, coupled to the second end of the hollow cathode; and
a getter layer supported by an inner and outer wall of the hollow cathode.

45. The system of claim 44, wherein said getter layer is coupled to the inner and outer wall of the hollow cathode.

46. The system of claim 44, wherein said getter layer is affixed to the inner and outer wall of the hollow cathode.

47. The system of claim 44, wherein said lamp structure includes a light bulb, wherein said fixed part extends through the light bulb and is supported thereby.

48. The system of claim 44, wherein said fixed part includes an electrical conductor for connecting the hollow cathode to a power source.

49. The system of claim 44, wherein said fixed part supports the hollow cathode.
